(19) United States
(12) Patent Application Publication
(10) Pub. No.: US 2024/0159426 A1
(43) Pub. Date: May 16, 2024

(54) AIR CONDITIONING SYSTEM AND AIR CONDITIONING METHOD USING THE SAME

(71) Applicant: Samsung Electronics Co., Ltd., Suwon-si (KR)

(72) Inventor: Moonki KIM, Suwon-si (KR)

(73) Assignee: Samsung Electronics Co., Ltd., Suwon-si (KR)

(21) Appl. No.: 18/365,410

(22) Filed: Aug. 4, 2023

(30) Foreign Application Priority Data
Nov. 15, 2022 (KR) 10-2022-0152906

(51) Int. Cl. F24F 13/28; B01D 46/00; B01D 46/44; B01D 46/58; F24F 3/167; F24F 11/74

(52) U.S. Cl. CPC F24F 13/28; B01D 46/0036; B01D 46/448; B01D 46/58; F24F 3/167; F24F 11/74; F24F 8/15

(57) ABSTRACT

An air conditioning system includes a temperature control unit, first and second filter units, and clean room equipment. The temperature control unit discharges temperature-controlled purified air through at least one of first or second outlets. The first and second filter units each filter purified air received from the temperature control unit based on using respective first and second filter modules. The first and second filter units include separate, independent housings. The air conditioning system blocks air flow from the temperature control unit into the second filter unit during an operation of the first filter module to filter purified air received at the first filter unit from the temperature control unit, and blocks air flow from the temperature control unit into the first filter unit during an operation of the second filter module to filter purified air received at the second filter unit from the temperature control unit.

### CROSS-REFERENCE TO RELATED APPLICATION

This application claims priority to and the benefit of Korean Patent Application No. 10-2022-0152906 filed in the Korean Intellectual Property Office on Nov. 15, 2022, the entire contents of which are incorporated herein by reference.

### BACKGROUND

### 1. Field

The present inventive concepts relate to air conditioning systems and air conditioning methods using the same.

### 2. Description of the Related Art

In order to ensure optimal semiconductor yield in a semiconductor manufacturing process, contaminant materials included in the air must be reduced or eliminated.

To this end, in an air conditioning system of the semiconductor manufacturing process, a filter unit continuously removes dust and other contaminants from circulating air to supply purified air into a clean room.

In order to effectively remove contaminants, it is necessary to periodically replace the filter used in the filter unit.

However, in order to replace the filter mounted on the filter unit, all power of a temperature control unit that is connected to the filter unit and controls a temperature of the air must be turned off. In addition, since it is required to initialize equipment after filter replacement work, and to perform stabilization for a certain period of time until a temperature is restored to a temperature required for an operation of the equipment, productivity may be reduced. In addition, since the contamination and temperature are not temporarily controlled, there is a very high risk of contamination of the equipment positioned in the clean room or the process data being changed.

### SUMMARY

Some example embodiments provide an air conditioning system and an air conditioning method using the same that does not need to turn off a power source of connected equipment when replacing a filter of a filter unit.

In some example embodiments, an air conditioning system, may include a temperature control unit, first and second filter units, and clean room equipment. The temperature control unit may include a first outlet and a second outlet. The temperature control unit may be configured to control a temperature of purified air and discharge the purified air through at least one of the first outlet or the second outlet. The first filter unit may be configured to filter purified air received at the first filter unit from the temperature control unit based on using a first filter module. The second filter unit may be configured to filter purified air received at the second filter unit from the temperature control unit based on using a second filter module. The clean room equipment may include a first inlet and a second inlet that are each configured to receive filtered air from at least one of the first filter unit or the second filter unit. The first filter unit and the second filter unit may include separate, independent housings. The air conditioning system may be configured to block air flow from the temperature control unit into the second filter unit during an operation of the first filter module to filter purified air received at the first filter unit from the temperature control unit. The air conditioning system may be configured to block air flow from the temperature control unit into the first filter unit during an operation of the second filter module to filter purified air received at the second filter unit from the temperature control unit.

According to some example embodiments, an air conditioning method may include: controlling a temperature of purified air to be in a set temperature range; filtering the purified air controlled to be in the set temperature range through a first filter unit or a second filter unit; and directing air filtered through the first filter unit or the second filter unit to flow into clean room equipment. The method may further include: during an operation of a first filter module of the first filter unit, blocking the purified air controlled to be in the set temperature range from flowing into the second filter unit, and flowing the purified air controlled to be in the set temperature range into the first filter unit. The method may further include: during an operation of a second filter module of the second filter unit, blocking the purified air controlled to be in the set temperature range from flowing into the first filter unit, and flowing the purified air controlled to be in the set temperature range into the second filter unit.

In some example embodiments, an air conditioning system may include a temperature control unit, first and second filter units, and clean room equipment. The temperature control unit may include a first outlet and a second outlet. The temperature control unit may be configured to control a temperature of purified air and discharge the purified air through at least one of the first outlet or the second outlet. The first filter unit may be configured to filter purified air received at the first filter unit from the temperature control unit based on using a first filter module. The second filter unit may be configured to filter purified air received at the second filter unit from the temperature control unit based on using a second filter module. The clean room equipment may include a first inlet and a second inlet that are each configured to receive filtered air from at least one of the first filter unit or the second filter unit. The first filter unit and the second filter unit may include separate, independent housings. The air conditioning system may be configured to, during an operation of the first filter module to filter purified air received at the first filter unit from the temperature control unit, block air flow from the temperature control unit into the second filter unit and further block air flow from the second filter unit into both the first inlet of the clean room equipment and the second inlet of the clean room equipment. The air conditioning system may be configured to, during an operation of the second filter module to filter purified air received at the second filter unit from the temperature control unit, block air flow from the temperature control unit into the first filter unit and further block air flow from the first filter unit into both the first inlet of the clean room equipment and the second inlet of the clean room equipment.

According to some example embodiments, since it is not necessary to turn off a power source of a connection equipment when replacing a filter of a filter unit, a time for temperature stabilization of a temperature control unit is not required, so that productivity may be remarkably improved.

In addition, it is possible to accurately keep a filter replacement time, thereby reducing, minimizing, or preventing organic and basic contamination due to a decrease in filter efficiency.

In addition, since a process may be performed without changing equipment conditions and environment even when replacing a filter, a risk of quality change of products produced in a clean room due to contamination of the products produced in the clean room may be reduced, minimized, or eliminated.

Various advantageous merits and effects of the present inventive concepts are not limited to the above-descriptions and will be easily understood while some example embodiments are described in detail.

### BRIEF DESCRIPTION OF THE DRAWINGS

FIG. 1 schematically illustrates an air conditioning system according to some example embodiments.

FIG. 2 schematically illustrates an air conditioning system according to some example embodiments.

FIG. 3 illustrates a disposition structure of a first filter unit and a second filter unit in an air conditioning system according to some example embodiments.

FIG. 4 illustrates a plan view viewed from a direction A of FIG. 3.

FIG. 5 illustrates a side view viewed from a direction B of FIG. 3.

FIG. 6 illustrates a disposition structure of a first filter unit and a second filter unit in an air conditioning system according to some example embodiments.

FIG. 7 illustrates a disposition structure of a first filter unit and a second filter unit in an air conditioning system according to some example embodiments.

FIG. 8 schematically illustrates flow of air when a first filter unit is operated in order to explain an air conditioning method according to some example embodiments.

FIG. 9 schematically illustrates flow of air when a second filter unit is operated in order to explain an air conditioning method according to some example embodiments.

FIG. 10 schematically illustrates flow of air when a first filter unit is operated in order to explain an air conditioning method according to some example embodiments.

FIG. 11 schematically illustrates flow of air when a second filter unit is operated in order to explain an air conditioning method according to some example embodiments.

### DETAILED DESCRIPTION

The present inventive concepts will be described more fully hereinafter with reference to the accompanying drawings, in which some example embodiments of the inventive concepts are shown. As those skilled in the art would realize, the described example embodiments may be modified in various different ways, all without departing from the spirit or scope of the present inventive concepts.

In order to clearly describe the present inventive concepts, parts or portions that are irrelevant to the description are omitted, and identical or similar constituent elements throughout the specification are denoted by the same reference numerals.

Further, in the drawings, the size and thickness of each element are arbitrarily illustrated for ease of description, and the present inventive concepts are not necessarily limited to those illustrated in the drawings. In the drawings, the thicknesses of layers, films, panels, regions, areas, etc., are exaggerated for clarity. In the drawings, for ease of description, the thicknesses of some layers and areas are exaggerated.

It will be understood that when an element such as a layer, film, region, area, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Hereinafter, the terms “above” or “on” may include not only those that are directly on in a contact manner, but also those that are above in a non-contact manner. The singular forms “a,” “an,” and “the” as used herein are intended to include the plural forms as well unless the context clearly indicates otherwise. It will be understood that the terms “comprise,” “include,” or “have” as used herein specify the presence of stated elements, but do not preclude the presence or addition of one or more other elements.

The use of the term “the” and similar demonstratives may correspond to both the singular and the plural. Operations constituting methods may be performed in any suitable order unless otherwise indicated herein or otherwise clearly contradicted by context, and are not necessarily limited to the stated order.

The use of all illustrations or illustrative terms in some example embodiments is simply to describe the technical ideas in detail, and the scope of the present inventive concepts is not limited by the illustrations or illustrative terms unless they are limited by claims.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular” with regard to other elements and/or properties thereof will be understood to be “perpendicular” with regard to the other elements and/or properties thereof within manufacturing tolerances and/or material tolerances and/or have a deviation in magnitude and/or angle from “perpendicular,” or the like with regard to the other elements and/or properties thereof that is equal to or less than 10% (e.g., a. tolerance of ±10%).

Elements and/or properties thereof (e.g., structures, surfaces, directions, or the like) that are “substantially parallel” with regard to other elements and/or properties thereof will be understood to be “parallel” with regard to the other elements and/or properties thereof within manufacturing tolerances and/or material tolerances and/or have a deviation in magnitude and/or angle from “parallel,” or the like with regard to the other elements and/or properties thereof that is equal to or less than 10% (e.g., a. tolerance of ±10%).

Elements and/or properties thereof (e.g., structures, surfaces, directions, or the like) that are “substantially coplanar” with regard to other elements and/or properties thereof will be understood to be “coplanar” with regard to the other elements and/or properties thereof within manufacturing tolerances and/or material tolerances and/or have a deviation in magnitude and/or angle from “coplanar,” or the like with regard to the other elements and/or properties thereof that is equal to or less than 10% (e.g., a. tolerance of ±10%)).

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

While the term “same,” “equal” or “identical” may be used in description of some example embodiments, it should be understood that some imprecisions may exist. Thus, when one element is referred to as being the same as another element, it should be understood that an element or a value is the same as another element within a desired manufacturing or operational tolerance range (e.g., ±10%).

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

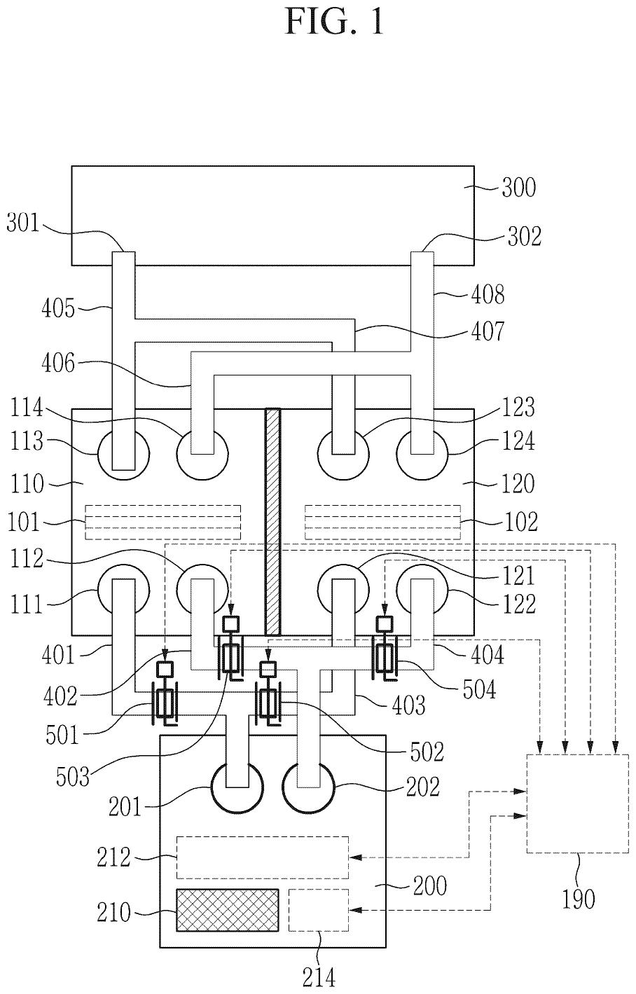

Hereinafter, an air conditioning system according to some example embodiments will be described with reference to FIG. 1.

FIG. 1 schematically illustrates an air conditioning system according to some example embodiments.

Referring to FIG. 1, an air conditioning system according to some example embodiments may include a temperature control unit 200, a first filter unit 110, a second filter unit 120, and clean room equipment 300.

Generally, a line structure of a building in which semiconductors are manufactured includes an FAB that is an area in which a semiconductor process is performed and in which an operation and maintenance of a production equipment are performed, and a sub-FAB that is a space in which an auxiliary equipment that provides gas and chemical substances for a process to the production equipment and remove residual chemical substances after the process is performed is positioned.

Here, the FAB is a clean room. Typically, since particles, temperature, humidity, airflow, vibration, ozone, an organic matter, and the like affect a product yield and the like depending on the semiconductor process, the outside air supplied into the clean room and the air circulated inside the clean room may need to be controlled at a standard suitable for semiconductor manufacturing.

When the purified air in which the particles, ozone, and the like have been removed after flowing from the outside (e.g., an exterior of the FAB, an exterior of the air conditioning system, etc.) flows into an inlet 210 of the temperature control unit 200, the purified air is controlled to be maintained in an appropriate temperature range according to a range required by the equipment positioned in the clean room (e.g., by one or more heat exchangers 212 of the temperature control unit 200) and then is discharged through a first outlet 201 and a second outlet 202. For example, the temperature of the clean room affects an activity condition (comfortability) of a worker and a change in characteristic of each process. Particularly, photo processing requires ultra-constant-temperature, since thermal expansion of a photomask, wafers, and other mechanical parts becomes a problem. In addition, the temperature of the air provided to the clean room may affect the change in physical properties of a photosensitive material (PR), and when a temperature is unstable in spatial distribution, it causes the airflow in the clean room due to a thermophoretic effect and acts as a factor inducing diffusion of particles. Therefore, the temperature of air provided to the clean room and/or clean room equipment 300 may be controlled to be to be maintained at an appropriate temperature range through the temperature control unit 200.

In some example embodiments, the temperature control unit 200 includes a heat exchanger 212 that is configured to adjust (e.g., control) a temperature of air (e.g., purified air) received into the temperature control unit 200 via the inlet 210 and discharged through a first outlet 201 and a second outlet 202 to have a temperature in an appropriate temperature range according to a range required by the equipment positioned in the clean room. The heat exchanger 212 may include, for example, a heat pump, a heat pipe heat exchanger (HPHE), or the like. The temperature control unit 200 may be configured to direct air received through inlet 210 to flow in heat transfer communication with one or more heat exchangers 212 to adjust the temperature of the purified air to be in a particular (e.g., set) temperature range.

In some example embodiments, the air conditioning system includes an air moving device 214 that is configured to induce flow of air through at least a portion of the air conditioning system. In some example embodiments, the air moving device 214 may include a fan. In some example embodiments, the air moving device 214 is included within the temperature control unit 200, but example embodiments are not limited thereto. In some example embodiments, the air conditioning system does not include any air moving devices 214, and air moving devices are external to the air conditioning system to induce air flow through the air conditioning system.

In some example embodiments, the air conditioning system includes a controller 190 that is configured to control one or more operations of one or more elements of the air conditioning system based on controlling operation of various devices, equipment, or the like of the air conditioning system. In some example embodiments, the controller 190 is external to the temperature control unit 200, but example embodiments are not limited thereto, and in some example embodiments the controller 190 may be included within the temperature control unit 200. The controller 190 may be communicatively coupled (e.g., electrically coupled) to one or more control devices of the heat exchanger 212, to one or more air moving devices 214, one or more dampers of the air conditioning system as described herein (e.g., any of the dampers 501, 502, 503, 504, 505, 506, 507, and/or 508), or the like. The controller 190 may be configured to generate electrical signals to operate, and thus control, some or all of such devices of the air conditioning system to control operations of the air conditioning system, including controlling the temperature adjustment (e.g., heating and/or cooling) of purified air in the temperature control unit 200, controlling a flow of air through one or more portions of the air conditioning system based on controlling operation of one or more air moving devices 214, and controlling operation some or all of any dampers of the air conditioning system according to any of the example embodiments (e.g., any of the dampers 501, 502, 503, 504, 505, 506, 507, and/or 508) in order to selectively direct, block, etc. air flow from the temperature control unit 200 into one of the first filter unit 110 or the second filter unit 120 and further into the clean room equipment 300.

The controller 190 may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, and/or portions thereof according to any of the example embodiments, and/or any portions thereof.

In some example embodiments, the clean room equipment 300 may be, for example, exposure equipment. In addition, the temperature of the air controlled by the temperature control unit 200 (e.g., based on operation of the heat exchanger 212) may be in a range of about 20° C. to about 25° C., and may be specifically controlled to about 22° C.

Meanwhile, the first filter unit 110 and the second filter unit 120 may each filter the air introduced (e.g., received) from the temperature control unit 200 by using a first filter module 101 and a second filter module 102, respectively. The first filter module 101 may be interchangeably referred to as a first filter device. The second filter module 102 may be interchangeably referred to as a second filter device.

The air filtered by the first filter unit 110 or the second filter unit 120 may be introduced (e.g., received) in the clean room equipment 300 positioned inside the clean room through a first inlet 301 and a second inlet 302.

The clean room is a certain area or space in which the number of dust contained in the air is managed within a prescribed limit, or a clean area in which dust, and various environmental conditions such as temperature, humidity, wind speed, differential pressure, and various contaminations are maintained and managed in accordance with a certain standard. The clean room may be required to remove particles (dust) and germs in the air that cause significant disturbance in the semiconductor manufacturing process, and the clean room equipment 300 refers to equipment for the semiconductor manufacturing positioned in the clean room, and may be, for example, an exposure equipment configured to at least partially perform a photo process to at least partially manufacture one or more semiconductor devices.

As contaminants are collected in a filter (e.g., one or more of the first filter module 101 or the second filter module 102), the efficiency of the filter may decrease. Therefore, in order to maintain the air flowing into the clean room equipment at a desired level, it may be necessary to replace the filter before the efficiency of the filter decreases.

In some example embodiments, the first filter unit 110 and the second filter unit 120 are each respectively configured as an independent housing, such that the first filter unit 110 and the second filter unit 120 includes separate, respective (e.g., separate, independent) housings that may be spaced apart from each other, isolated from each other, or the like. The independent housings of the first filter unit 110 and the second filter unit 120 may isolate the first and second filter modules 101 and 102 from each other. Accordingly, while the first filter module 101 is operating to filter purified air received at the first filter unit 110 from the temperature control unit 200, the air flowing into the second filter unit 120 from the temperature control unit 200 is blocked, and while the second filter module 102 is operating to filter purified air received at the second filter unit 120 from the temperature control unit 200, the air flowing into the first filter unit 110 from the temperature control unit 200 is blocked.

That is, the first filter unit 110 and the second filter unit 120 do not simultaneously operate, and while one of the first filter unit 110 and the second filter unit 120 is operating, the other thereof is not used and a filter is preliminarily installed in the corresponding filter module.

Accordingly, even when the first filter module 101 or the second filter module 102 is replaced, it is possible to continuously provide filtered air to the clean room equipment 300 without the need to turn off the power of (e.g., deactivate) the temperature control unit 200, and it is possible to accurately keep the filter replacement period. Accordingly, there is an advantage of reducing, minimizing, or preventing organic and basic contamination due to filter efficiency deterioration.

In addition, since a process may be performed without changing equipment conditions and environment even when the filter is replaced, a risk of quality change due to contamination of products produced in the clean room may be reduced, minimized, or eliminated, operation of the air conditioning system to supply filtered, purified air to the clean room equipment 300 has a very advantageous effect of reducing, minimizing, or preventing manufacturing defects in semiconductor devices manufactured in a clean room based on operation of the clean room equipment 300 due to contaminants in the air received at the clean room equipment 300 from the first and/or second filter units 110 and/or 120.

Specifically, the air conditioning system is configured to cause air discharged through the first outlet 201 to flow into a first filter unit inlet 111 of the first filter unit 110 or a third filter unit inlet 121 of the second filter unit 120. In addition, air conditioning system is configured to cause the air discharged through the second outlet 202 to flow into a second filter unit inlet 112 of the first filter unit 110 or a fourth filter unit inlet 122 of the second filter unit 120.

The first outlet 201 and the first filter unit inlet 111 are connected through a first connecting pipe 401, and the second outlet 202 and the second filter unit inlet 112 are connected through a second connecting pipe 402. In some example embodiments, a first damper 501 is positioned within the first connecting pipe 401, and a third damper 503 is positioned within the second connecting pipe 402.

In addition, the first outlet 201 and the third filter unit inlet 121 are connected through a third connecting pipe 403, and the second outlet 202 and the fourth filter unit inlet 122 are connected through a fourth connecting pipe 404. In some example embodiments, a second damper 502 is positioned within the third connecting pipe 403, and a fourth damper 504 is positioned within the fourth connecting pipe 404.

The first to fourth dampers 501, 502, 503, and 504 are members (e.g., dampers) capable of blocking air flow and are positioned within respective connecting pipes, and manipulators for manipulating these dampers are positioned outside respective connecting pipes.

The first to fourth dampers 501, 502, 503, and 504 are members for blocking or opening air flow based on being closed or opened, respectively. For example, the air conditioning system may be configured to (e.g., based on the controller 190 generating control signals to control operation of at least some of the first to fourth dampers 501 to 504) selectively direct air flow from the temperature control unit 200, through the second filter unit 120, and to the clean room equipment 300, during the operation of the second filter unit 120 to filter purified air received at the second filter unit 120 from the temperature control unit 200, such that the first damper 501 and the third damper 503 may be blocked (e.g., closed) to cause the air flowing into the first filter unit 110 to be blocked, while the second and fourth dampers 502 and 504 may be (or, alternatively, remain) opened. In some example embodiments, since the second damper 502 and the fourth damper 504 are opened, even when (e.g., while) the filter of the first filter module 101 is replaced, without turning off the power of (e.g., deactivating) the temperature control unit 200, the air filtered through the second filter module 102 continues to flow into the clean room equipment 300 without change to the temperature and/or filtered state of the air received at the clean room equipment 300.

Meanwhile, the air conditioning system may be configured to (e.g., based on the controller 190 generating control signals to control operation of at least some of the first to fourth dampers 501 to 504) selectively direct air flow from the temperature control unit 200, through the first filter unit 110, and to the clean room equipment 300, such that the second damper 502 and the fourth damper 504 may be closed (e.g., blocked) to cause the air flowing into the second filter unit 120 to be blocked, while the first and third dampers 501 and 503 may be (or, alternatively, remain) opened. In some example embodiments, since the first damper 501 and the third damper 503 are opened, even when (e.g., while) the filter of the second filter module 102 is replaced, without turning off the power of the temperature control unit 200, the air filtered through the first filter module 101 continues to flow into the clean room equipment 300 without change to the temperature and/or filtered state of the air received at the clean room equipment 300.

In some example embodiments, each of the first damper 501, the second damper 502, the third damper 503, and the fourth damper 504 may be manually or electrically operated. When each of the first, second, third, and fourth dampers 501, 502, 503, and 504 is electrically operated (e.g., based on the first, second, third, and fourth dampers 501, 502, 503, and 504 each including an electrically powered actuator, such as a servo actuator, that is communicatively coupled to the controller 190), the convenience of operation of the damper is improved because a person does not need to directly operate it. As shown in at least FIG. 1, in some example embodiments the first to fourth dampers 501, 502, 503, and 504 may be communicatively coupled to a controller 190 of the air conditioning system, such that the air conditioning system may be configured to independently control (e.g., operate) each of the first to fourth dampers 501, 502, 503, and 504 to be open or closed to thus selectively flow or block air from the temperature control unit 200 to one of the first or second filter units 110 or 120, based on controller 190 generating control signals to one or more of the first to fourth dampers 501, 502, 503, and 504 (e.g., based on a processor of the controller 190 executing a program of instructions stored at a memory of the controller 190). In some example embodiments, the controller 190 may adjustably control the first to fourth dampers 501, 502, 503, and 504, for example based on receiving a command from a user via a user interface of the controller 190 (e.g., a button interface, touchscreen display interface, or the like) to selectively flow (e.g., enable) or block air flow through a selected one of the first filter unit 110 or the second filter unit 120.

Meanwhile, each of the first filter module 101 and the second filter module 102 may include one of a chemisorptive filter or a physisorptive filter.

The chemisorptive filter may include porous, chemisorptive media formed with a copolymer having an acidic functional group that enables the group to react with a reagent. The physisorptive filter includes physisorptive media, such as untreated, activated carbon. The term “untreated” as used herein means an activated carbon that has not been modified by chemical treatment to perform chemisorption; rather, untreated, active carbon remains as a physical, or nonpolar, adsorbent. The physisorptive media remove organic and inorganic condensable contaminants, typically those having a boiling point greater than 150° C. via physisorption, while the chemisorptive media remove basic vapors via chemisorption.

The term “physisorption” refers to a reversible adsorption process in which the adsorbate is held by weak physical forces. In contrast, the term, “chemisorption” refers to an irreversible chemical reaction process in which chemical bonds are formed between gas or liquid molecules and a solid surface. The relative thicknesses of the chemisorptive filter and the physisorptive filter can be engineered so that the useful life of the two filter elements will be exhausted at approximately the same time in a given environment.

If desired, in the first filter module 101 and the second filter module 102, a HEPA filter may be used in conjunction with the chemisorptive filter and the physisorptive filter to reduce the overall level of nonchemical particulate matter such as dust or pollen.

Next, the first connecting pipe 401, the second connecting pipe 402, the third connecting pipe 403, and the fourth connecting pipe 404 may be made of, for example, a stainless steel (SUS) material. However, this is an example, and the first connecting pipe 401, the second connecting pipe 402, the third connecting pipe 403, and the fourth connecting pipe 404 may be configured by using a flexible material according to a space or environment to which the air conditioning system of some example embodiments is applied.

The air conditioning system may be configured to cause air filtered by the first filter unit 110 or the second filter unit 120 to flow into the clean room equipment 300 through a first inlet 301 and a second inlet 302. That is, the first inlet 301 and the second inlet 302 are connected to the clean room equipment 300. For example, when the clean room equipment 300 is an exposure equipment, air whose temperature is controlled to about 20° C. to about 25° C., about 21° C. to about 23° C., and/or about 22° C. may be introduced into the exposure equipment through the first inlet 301 and the second inlet 302. When the temperature of the exposure equipment is controlled in these ranges, thermal expansion of the photomask, wafer, and other mechanical parts included in the exposure equipment may be reduced, minimized, or prevented.

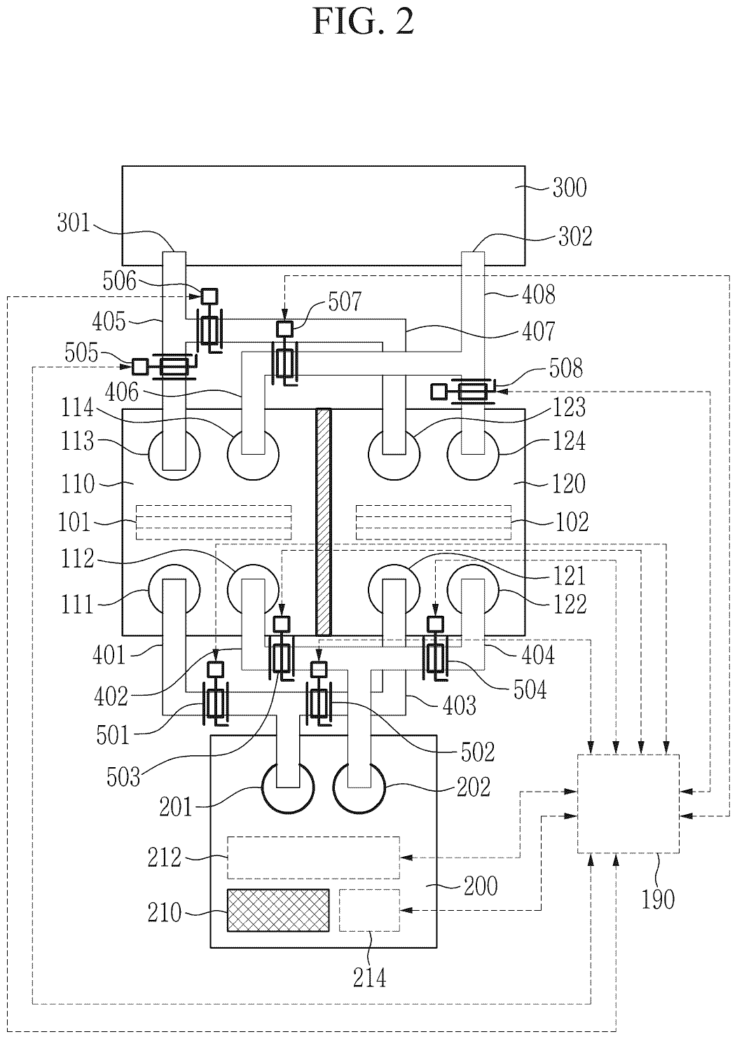

Hereinafter, some example embodiments will be described in conjunction with the drawings. In the example embodiments to be described below with reference to at least FIGS. 2-11, the same content as in the example embodiments described above with reference to FIG. 1 will be omitted, and differences will be mainly described. In addition, the same reference numerals are used for the same components as in the example embodiments described with reference to FIG. 1.

FIG. 2 schematically illustrates an air conditioning system according to some example embodiments. Some example embodiments are different from the previous example embodiments described above with reference to FIG. 1 in that one or more additional dampers are included.

Referring to FIG. 2, in some example embodiments, an additional damper is provided between the first filter unit 110 or the second filter unit 120 and the first inlet 301 and the second inlet 302 to which the air filtered by the first or second filter unit 110 or 120 is supplied.

Specifically, the air conditioning system may be configured to cause the first inlet 301 to receive the filtered air from a first filter unit outlet 113 of the first filter unit 110 or a third filter unit outlet 123 of the second filter unit 120.

In addition, the air conditioning system may be configured to cause the second inlet 302 to receive the filtered air from a second filter unit outlet 114 of the first filter unit 110 or a fourth filter unit outlet 124 of the second filter unit 120.

In some example embodiments, the first filter unit outlet 113 and the first inlet 301 are connected through a fifth connecting pipe 405, and the second filter unit outlet 114 and the second inlet 302 are connected through a sixth connecting pipe 406. A fifth damper 505 is positioned within the fifth connecting pipe 405, and a seventh damper 507 is positioned within the sixth connecting pipe 406.

In addition, the third filter unit outlet 123 and the first inlet 301 are connected through a seventh connecting pipe 407, and the fourth filter unit outlet 124 and the second inlet 302 are connected through an eighth connecting pipe 408. A sixth damper 506 is positioned within the seventh connecting pipe 407, and an eighth damper 508 is positioned within the eighth connecting pipe 408.

The fifth to eighth dampers 505, 506, 507, and 508 are members capable of blocking air flow and are positioned within respective connecting pipes, and manipulators for manipulating these dampers are positioned outside respective connecting pipes.

In some example embodiments, the air conditioning system may be configured to (e.g., based on the controller 190 generating control signals to control operation of at least some of the first to eighth dampers 501 to 508) selectively direct air flow from the temperature control unit 200, through the second filter unit 120, and to the clean room equipment 300, during the operation of the second filter unit 120 to filter purified air received at the second filter unit 120 from the temperature control unit 200, such that the above-described first and third dampers 501 and 503 are blocked (e.g., closed), and additionally, the fifth and seventh dampers 505 and 507 are blocked together. In this way, when the fifth damper 505 and the seventh damper 507 are additionally installed and blocked (e.g., closed) when (e.g., while) the first filter module 101 is replaced, the shielding power provided by the dampers (e.g., to reduce, minimize, or prevent contaminants from reaching the clean room equipment 300 from the first filter unit 110) may be further improved so that air that is introduced (e.g., received from the temperature control unit 200) into the second filter module 102, filtered, and discharged (e.g., discharged to the clean room equipment) is not introduced into or passed through the first filter unit 110.

In addition, in some example embodiments, the air conditioning system may be configured to (e.g., based on the controller 190 generating control signals to control operation of at least some of the first to eighth dampers 501 to 508) selectively direct air flow from the temperature control unit 200, through the first filter unit 110, and to the clean room equipment 300, during the operation of the first filter unit 110 to filter purified air received at the first filter unit 110 from the temperature control unit 200, such that the above-described second and fourth dampers 502 and 504 are blocked, and additionally, the sixth and eighth dampers 506 and 508 are blocked together. In this way, when the sixth damper 506 and the eighth damper 508 are additionally installed and blocked when the second filter module 102 is replaced, the shielding power provided by the dampers (e.g., to reduce, minimize, or prevent contaminants from reaching the clean room equipment 300 from the second filter unit 120) may be further improved so that air that is introduced (e.g., received from the temperature control unit 200) into the first filter module 101, filtered, and discharged (e.g., discharged to the clean room equipment) is not introduced into or passed through the second filter unit 120.

In some example embodiments, each of the fifth damper 505, the sixth damper 506, the seventh damper 507, and the eighth damper 508 may also be manually or electrically operated. When the fifth, sixth, seventh, and eighth dampers 505, 506, 507, and 508 are electrically driven (e.g., based on the fifth, sixth, seventh, and eighth dampers 505, 506, 507, and 508 each including an electrically powered actuator, such as a servo actuator, that is communicatively coupled to the controller 190), the convenience of operating the dampers is improved as described above. As shown in at least FIG. 2, in some example embodiments the fifth to eighth dampers 505, 506, 507, and 508 may be communicatively coupled to a controller 190 of the air conditioning system, such that the air conditioning system may be configured to independently control (e.g., operate) each of the fifth to eighth dampers 505, 506, 507, and 508 to be open or closed to thus selectively flow or block air from one of the first or second filter units 110 or 120 to the clean room equipment 300, based on controller 190 generating control signals to one or more of the fifth to eighth dampers 505, 506, 507, and 508 (e.g., based on a processor of the controller 190 executing a program of instructions stored at a memory of the controller 190). In some example embodiments, the controller 190 may adjustably control the fifth to eighth dampers 505, 506, 507, and 508, for example based on receiving a command from a user via a user interface of the controller 190 (e.g., a button interface, touchscreen display interface, or the like) to selectively flow (e.g., enable) or block air flow through a selected one of the first filter unit 110 or the second filter unit 120.

In addition, the fifth connecting pipe 405, the sixth connecting pipe 406, the seventh connecting pipe 407, and the eighth connecting pipe 408 may be made of, for example, an SUS material. However, this is an example, and the fifth connecting pipe 405, the sixth connecting pipe 406, the seventh connecting pipe 407, and the eighth connecting pipe 408 may be configured by using a flexible material according to a space or environment to which the air conditioning system of some example embodiments is applied.

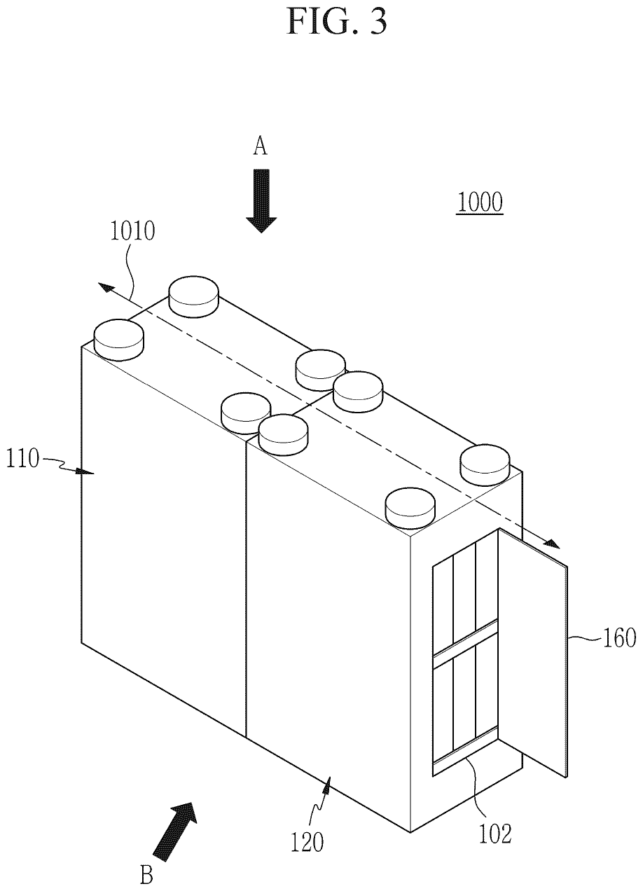

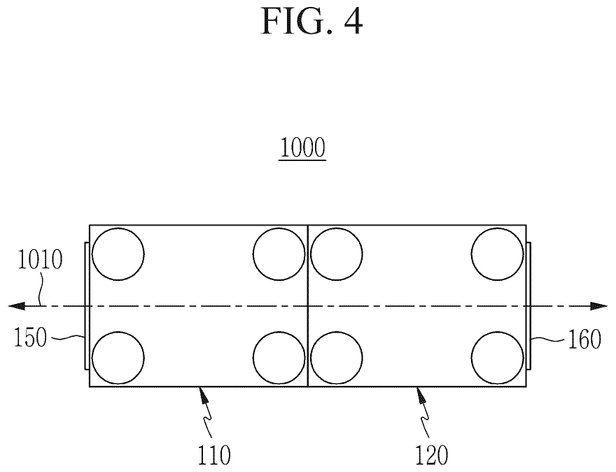

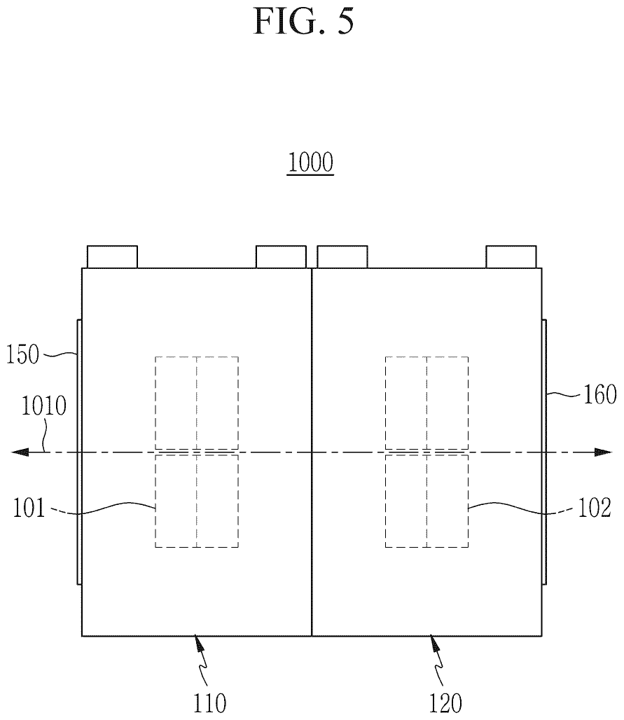

FIG. 3 illustrates a disposition structure of a first filter unit and a second filter unit in an air conditioning system according to some example embodiments. FIG. 4 illustrates a plan view viewed from a direction A of FIG. 3, and FIG. 5 illustrates a side view viewed from a direction B of FIG. 3.

Referring to FIG. 3 to FIG. 5, in an air conditioning system 1000 according to some example embodiments, which may be the air conditioning system shown in FIG. 1 and/or FIG. 2, the first filter unit 110 and the second filter unit 120 include doors 150 and 160 each connected to one surfaces thereof, respectively. For example, as shown, the first filter unit 110 may include a door 150 connected to one surface of the first filter unit 110, and the second filter unit 120 may include a separate door 160 connected to a separate surface of the second filter unit 120.

In some example embodiments, the door 150 of the first filter unit and the door 160 of the second filter unit are positioned at opposite sides of each other. That is, the housings of the first filter unit 110 and the second filter unit 120 are positioned back-to-back. For example, as shown in FIGS. 3 to 5, the door 150 of the first filter unit 110 and the separate door 160 of the second filter unit 120 may be at opposite sides in relation to each other across the combined first and second filter units 110 and 120 and thus may face in opposite directions along an axis 1010 that intersects both the first filter unit 110 and the second filter unit 120 (e.g., an axis that is perpendicular to both of the opposite-facing surfaces to which the doors 150 and 160 are connected.

In some example embodiments, the first filter module 101 is installed inside the first filter unit 110 and the second filter module 102 is installed inside the second filter unit 120.

The first filter module 101 and the second filter module 102 may include a plurality of parallel filter accommodating parts disposed therein.

The filter accommodating part may be disposed in two layers in parallel as shown in FIG. 3 and FIG. 5, or may be disposed in three layers (not shown) if necessary. Two to five filters may be disposed side by side on one layer, but the number of the filters is not particularly limited.

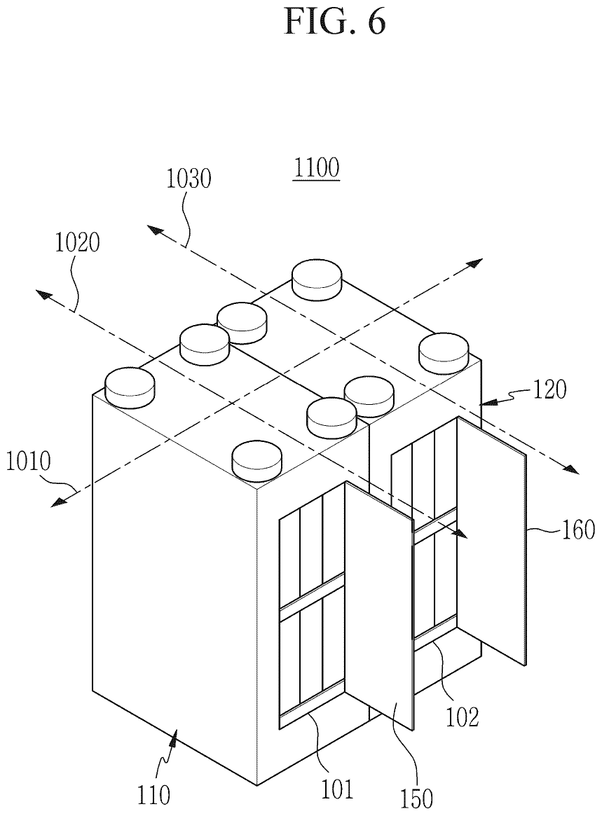

FIG. 6 illustrates a disposition structure of a first filter unit and a second filter unit in an air conditioning system according to some example embodiments.

Referring to FIG. 6, in an air conditioning system 1100 according to some example embodiments, which may be the air conditioning system shown in FIG. 1 and/or FIG. 2, the first filter unit 110 and the second filter unit 120 may be positioned side by side so that the door 150 of the first filter unit and the door 160 of the second filter unit face the same direction. For example, as shown in FIG. 6, the door 150 of the first filter unit 110 and the separate door 160 of the second filter unit 120 may face a same direction and may be connected to respective surfaces of the first and second filter units 110 and 120 that may be coplanar with each other, and/or where the doors 150 and 160 may face in respective directions along respective axes 1020 and 1030 that may be parallel to each other and may each intersect only one of the first or second filter units 110 and 120 and may intersect and/or be perpendicular to the axis 1010 that intersects both the first filter unit 110 and the second filter unit 120.

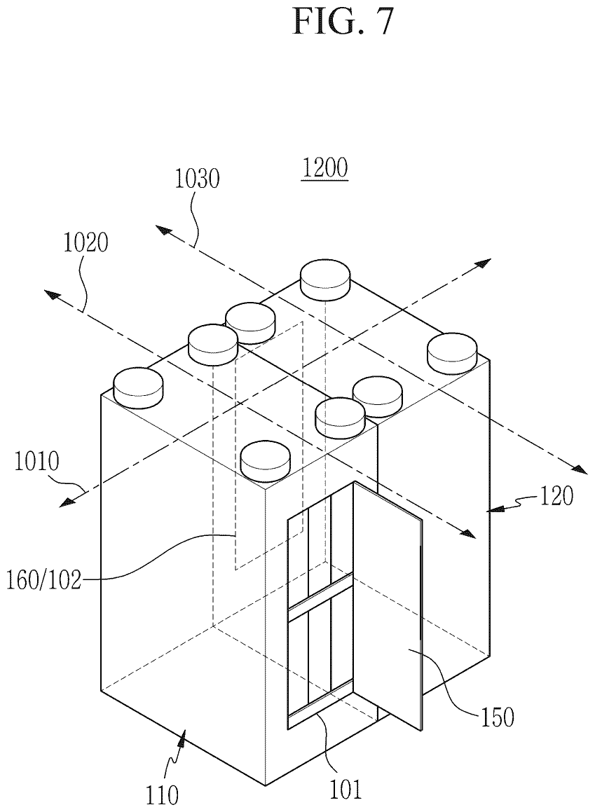

FIG. 7 illustrates a disposition structure of a first filter unit and a second filter unit in an air conditioning system according to some example embodiments.

Referring to FIG. 7, in an air conditioning system 1200 according to some example embodiments, which may be the air conditioning system shown in FIG. 1 and/or FIG. 2, the first filter unit 110, and the second filter unit 120 may be positioned side by side so that the door 150 of the first filter unit and the door 160 of the second filter unit face in opposite directions. For example, as shown in FIG. 6, the door 150 of the first filter unit 110 and the separate door 160 of the second filter unit 120 may face opposite directions direction and may be connected to respective surfaces of the first and second filter units 110 and 120 that may extend in parallel to each other and may be opposite-facing in opposite directions, and/or where the doors 150 and 160 may face in respective opposite directions along respective axes 1020 and 1030 that may be parallel to each other and may each intersect only one of the first or second filter units 110 and 120 and may intersect and/or be perpendicular to the axis 1010 that intersects both the first filter unit 110 and the second filter unit 120.

As shown in FIG. 3, FIG. 6, and FIG. 7, the first filter unit 110 and the second filter unit are configured to have independent housings, and when the doors are positioned to facilitate replacement of the first filter module 101 and the second filter module 102, the disposition structure thereof is not particularly limited.

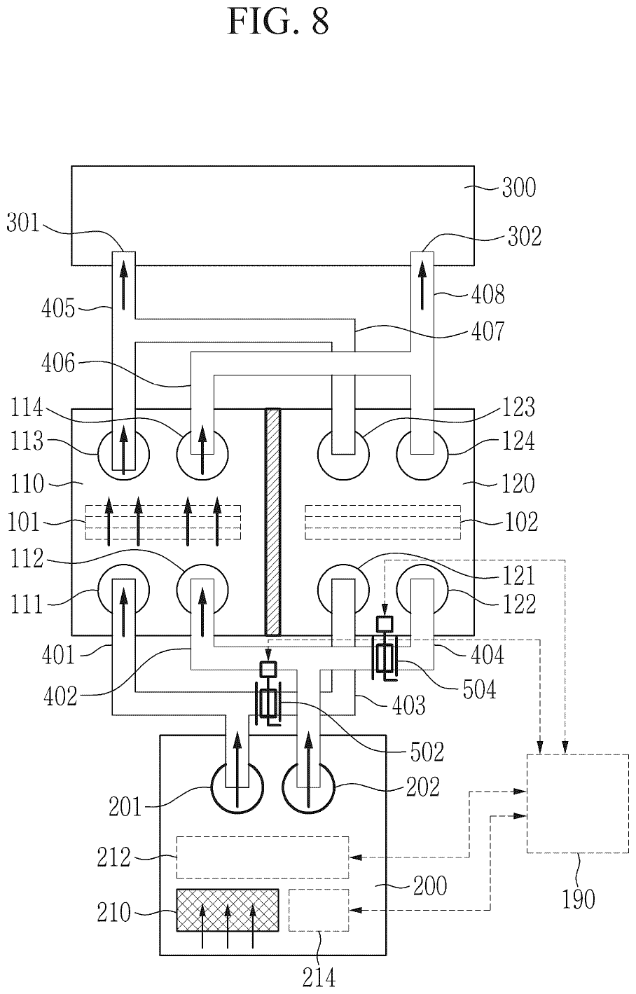

Hereinafter, an air conditioning method according to some example embodiments will be described with reference to FIG. 8 to FIG. 11. The air conditioning systems shown in FIGS. 8 to 11 may include the air conditioning system shown in FIG. 1 and/or the air conditioning system shown in FIG. 2. The air conditioning system according to some example embodiments may be configured to perform some or all of the method shown in FIGS. 8 to 11 based on the controller 190 controlling one or more elements of the air conditioning system (e.g., heat exchanger 212, air moving device 214, some or all of the first to eighth dampers 501 to 508, etc.).

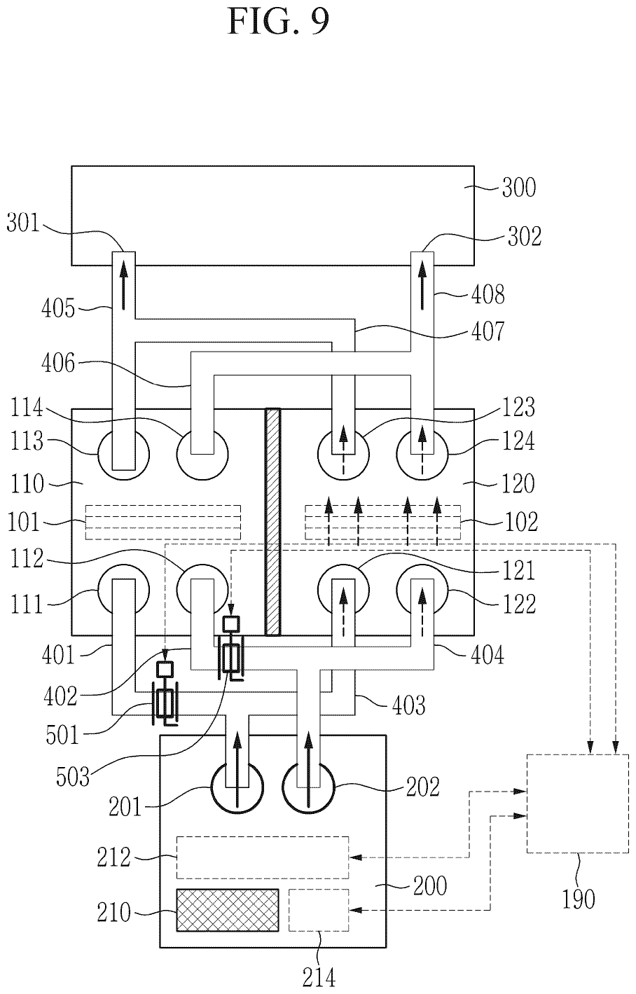

FIG. 8 schematically illustrates flow of air when a first filter unit is operated in order to explain an air conditioning method according to some example embodiments, and FIG. 9 schematically illustrates flow of air when a second filter unit is operated in order to explain an air conditioning method according to some example embodiments.

Referring to FIG. 8 and FIG. 9, an air conditioning method according to some example embodiments includes controlling purified air in a set temperature range (e.g., controlling at least the heat exchanger 212 to cause purified air received at the temperature control unit 200 to have a temperature in a particular (e.g., set) temperature range), selectively filtering the air controlled in the set temperature range (e.g., the purified air controlled to be in the set temperature range) from the temperature control unit 200 through the first filter module 101 or the second filter module 102, and selectively flowing (e.g., selectively directing) the air filtered through the first filter module 101 or the second filter module 102 into the clean room equipment 300.

Referring to FIG. 8, during the operation of the first filter module of the first filter unit (e.g., in response to a determination at the controller 190, for example in response to a user command received via a user interface of the air conditioning system, that the first filter module 101 is operating to filter purified air received at the first filter unit 110 from the temperature control unit 200), the air conditioning system may be configured to cause the flowing of air into the second filter unit 120 to be selectively blocked, and the first filter unit 110 to be selectively opened so that air flows into the first filter unit 110 from the temperature control unit 200.

Specifically, the air conditioning system (e.g., controller 190) may be configured to cause the purified air flowing into the inlet 210 of the temperature control unit 200 to be discharged through the first outlet 201 and the second outlet 202 after a temperature is controlled (e.g., based on operation of at least the heat exchanger 212) to meet a standard (e.g., to be within a particular temperature range, which may be a particular range stored at a memory of the controller 190). The temperature control unit 200 may include one or more temperature sensors (e.g., thermocouples), and the controller 190 may be configured to receive sensor data from the one or more temperature sensors and adjustably control a heat exchanger 212 and/or air moving device 214 based on the sensor data to adjust the temperature of purified air in the temperature control unit 200 to be in a set temperature range.

The air conditioning system may be configured to selectively direct air discharged through the first outlet 201 to flow into the first filter unit 110 through the first connecting pipe 401 connected to the first outlet 201 and the first filter unit inlet 111 (e.g., based on controlling at least the second damper 502 to be closed while the first damper 501 is opened). Subsequently, the air conditioning system may be configured to direct the air filtered through the first filter module 101 of the first filter unit 110 to be discharged through the first filter unit outlet 113 to flow into the clean room equipment 300 through the fifth connecting pipe 405 connecting the first filter unit outlet 113 and the first inlet 301.

The air conditioning system may be configured to selectively direct air discharged through the second outlet 202 to flow into the first filter unit 110 through the second connecting pipe 402 connected to the second outlet 202 and the second filter unit inlet 112 (e.g., based on controlling at least the fourth damper 504 to be closed while the third damper 503 is opened). Thereafter, the air conditioning system may be configured to selectively direct the air filtered through the first filter module 101 of the first filter unit 110 to be discharged through the second filter unit outlet 114 to flow into the clean room equipment 300 through the sixth connecting pipe 406 connecting the second filter unit outlet 114 and the second inlet 302.

Referring to FIG. 9, air conditioning system may be configured to, during the operation of the second filter module 102 of the second filter unit 120 (e.g., in response to a determination at the controller 190, for example in response to a user command received via a user interface of the air conditioning system, that the second filter unit 120 is operating to filter purified air received at the second filter unit 120 from the temperature control unit 200), the air conditioning system may be configured to cause the flowing of air into the first filter unit 110 to be selectively blocked, and the second filter unit 120 to be selectively opened so that air flows into the second filter unit 120 from the temperature control unit 200.

Specifically, the air conditioning system (e.g., controller 190) may be configured to cause the purified air flowing into the inlet 210 of the temperature control unit 200 to be discharged through the first outlet 201 and the second outlet 202 after a temperature is controlled to meet a standard (e.g., based on operation of at least the heat exchanger 212).

The air conditioning system may be configured to selectively direct air discharged through the first outlet 201 to flow into the second filter unit 120 through the third connecting pipe 403 connected to the first outlet 201 and the third filter unit inlet 121 (e.g., based on controlling at least the first damper 501 to be closed while the second damper 502 is opened). Subsequently, the air conditioning system may be configured to direct the air filtered through the second filter module 102 of the second filter unit 120 to be discharged through the third filter unit outlet 123 to flow into the clean room equipment 300 through the seventh connecting pipe 407 connecting the third filter unit outlet 123 and the first inlet 301.

The air conditioning system may be configured to selectively direct air discharged through the second outlet 202 to flow into the second filter unit 120 through the fourth connecting pipe 404 connected to the second outlet 202 and the fourth filter unit inlet 122 (e.g., based on controlling at least the third damper 503 to be closed while the fourth damper 504 is opened). Thereafter, the air conditioning system may be configured to selectively direct air filtered through the second filter module 102 of the second filter unit 120 is discharged through the fourth filter unit outlet 124 to flow into the clean room equipment 300 through the eighth connecting pipe 408 connecting the fourth filter unit outlet 124 and the second inlet 302.

In some example embodiments, the flowing or blocking of air into the first filter unit 110 and the second filter unit 120 is performed by using a manual damper or a motorized damper (e.g., based on the controller 190 generating one or more control signals to operate one or more of the dampers as described herein).

In addition, the first filter module 101 and the second filter module 102 include at least one of a chemisorptive filter and a physisorptive filter. This is the same as that described above, so a description thereof will be omitted here.

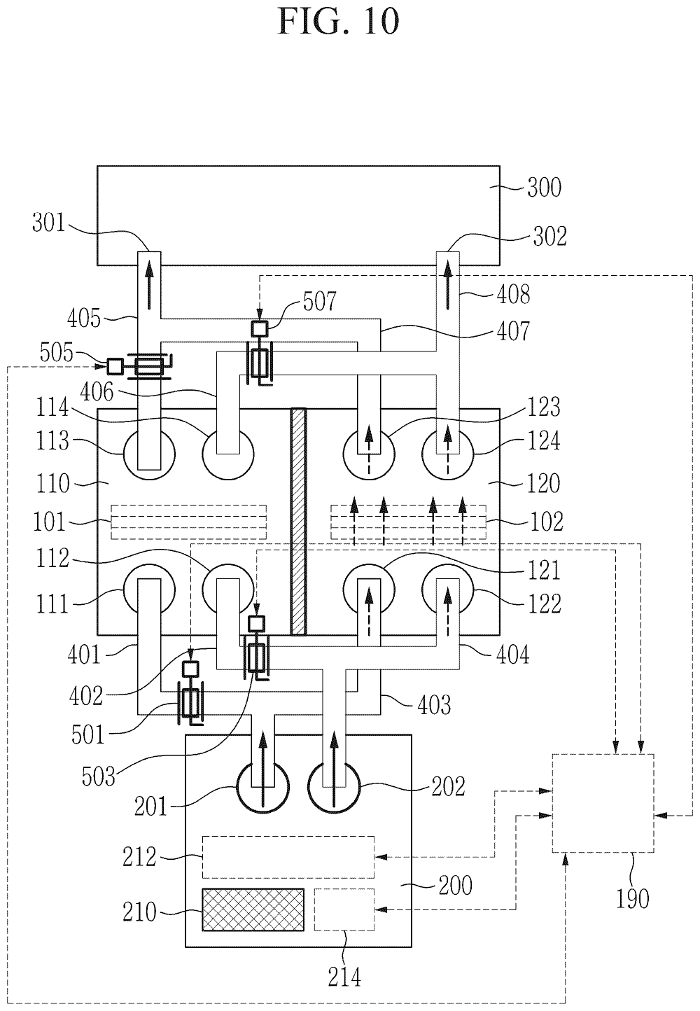

FIG. 10 schematically illustrates flow of air when a first filter unit is operated in order to explain an air conditioning method according to some example embodiments.

Referring to FIG. 10, an air conditioning method according to some example embodiments further includes blocking air from being introduced into the clean room equipment 300 from the first filter unit 110 during the operation of the second filter unit.

In some example embodiments, the blocking of the air flowing into the clean room equipment 300 from the first filter unit 110 is performed by using a manual damper or a motorized damper. FIG. 10 illustrates that air is blocked by using the fifth damper 505 and the seventh damper 507 (e.g., based on controlling at least the fifth and seventh dampers 505 and 507 to be closed while the sixth and eighth dampers 506 and 508 are opened).

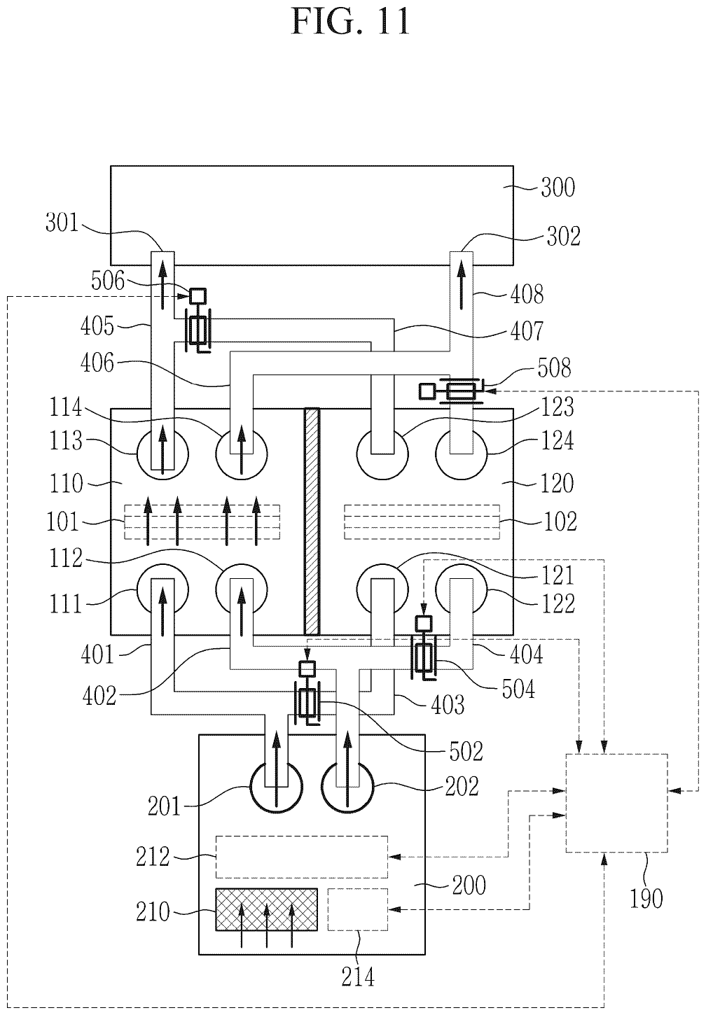

FIG. 11 schematically illustrates flow of air when a second filter unit is operated in order to explain an air conditioning method according to some example embodiments.

Referring to FIG. 11, an air conditioning method according to some example embodiments further includes blocking air from being introduced into the clean room equipment 300 from the second filter unit 120 during the operation of the first filter unit 110.

In some example embodiments, the blocking of the air flowing into the clean room equipment 300 from the second filter unit 120 is performed by using a manual damper or a motorized damper. FIG. 11 illustrates that air is blocked by using the sixth damper 506 and the eighth damper 508 (e.g., based on controlling at least the sixth and eighth dampers 506 and 508 to be closed while the fifth and seventh dampers 505 and 507 are opened).

While the inventive concepts have been described in connection with what is presently considered to be practical example embodiments, it is to be understood that the inventive concepts are not limited to the disclosed example embodiments, but, on the contrary, are intended to cover various modifications and equivalent arrangements included within the spirit and scope of the appended claims.

What is claimed is:

1. An air conditioning system, comprising:
a temperature control unit including a first outlet and a second outlet, the temperature control unit configured to control a temperature of purified air and discharge the purified air through at least one of the first outlet or the second outlet;
a first filter unit that is configured to filter purified air received at the first filter unit from the temperature control unit based on using a first filter module;
a second filter unit that is configured to filter purified air received at the second filter unit from the temperature control unit based on using a second filter module; and
clean room equipment including a first inlet and a second inlet that are each configured to receive filtered air from at least one of the first filter unit or the second filter unit,
wherein the first filter unit and the second filter unit include separate, independent housings,
wherein the air conditioning system is configured to
block air flow from the temperature control unit into the second filter unit during an operation of the first filter module to filter purified air received at the first filter unit from the temperature control unit, and
block air flow from the temperature control unit into the first filter unit during an operation of the second filter module to filter purified air received at the second filter unit from the temperature control unit.

2. The air conditioning system of claim 1, wherein the air conditioning system is configured to:
cause purified air discharged through the first outlet of the temperature control unit to flow into
a first filter unit inlet of the first filter unit, or
a third filter unit inlet of the second filter unit;
cause purified air discharged through the second outlet of the temperature control unit to flow into
a second filter unit inlet of the first filter unit, or
a fourth filter unit inlet of the second filter unit; and
selectively direct air flow from the temperature control unit, through the second filter unit, and to the clean room equipment during the operation of the second filter module, such that
a first damper in a first connecting pipe connecting the first outlet of the temperature control unit and the first filter unit inlet of the first filter unit and a third damper in a second connecting pipe connecting the second outlet of the temperature control unit and the second filter unit inlet of the first filter unit are blocked, and
a second damper in a third connecting pipe connecting the first outlet of the temperature control unit and the third filter unit inlet of the second filter unit and a fourth damper in a fourth connecting pipe connecting the second outlet of the temperature control unit and the fourth filter unit inlet of the second filter unit are opened.

3. The air conditioning system of claim 1, wherein the air conditioning system is configured to:
cause purified air discharged through the first outlet of the temperature control unit to flow into
a first filter unit inlet of the first filter unit, or
a third filter unit inlet of the second filter unit;
cause purified air discharged through the second outlet of the temperature control unit to flow into
a second filter unit inlet of the first filter unit, or
a fourth filter unit inlet of the second filter unit; and
selectively direct air flow from the temperature control unit, through the first filter unit, and to the clean room equipment during the operation of the first filter module, such that
a first damper in a first connecting pipe connecting the first outlet of the temperature control unit and the first filter unit inlet of the first filter unit and a third damper in a second connecting pipe connecting the second outlet of the temperature control unit and the second filter unit inlet of the first filter unit are opened, and
a second damper in a third connecting pipe connecting the first outlet of the temperature control unit and the third filter unit inlet of the second filter unit and a fourth damper in a fourth connecting pipe connecting the second outlet of the temperature control unit and the fourth filter unit inlet of the second filter unit are blocked.

4. The air conditioning system of claim 2, wherein
the first damper, the second damper, the third damper, and the fourth damper are each configured to be manually operated or electrically operated.

5. The air conditioning system of claim 1, wherein
the first filter module and the second filter module each include at least one of a chemisorptive filter or a physisorptive filter.

6. The air conditioning system of claim 1, wherein:
the first filter unit includes a first filter unit outlet and a second filter unit outlet;
the second filter unit includes a third filter unit outlet and a fourth filter unit outlet;
the first inlet of the clean room equipment is configured to receive filtered air from the first filter unit outlet of the first filter unit or filtered air from the third filter unit outlet of the second filter unit;
the second inlet of the clean room equipment is configured to receive filtered air from the second filter unit outlet of the first filter unit or filtered air from the fourth filter unit outlet of the second filter unit; and
the air conditioning system is configured to selectively direct air flow from the temperature control unit, through the second filter unit, and to the clean room equipment, during the operation of the second filter module, such that
a fifth damper in a fifth connecting pipe connecting the first filter unit outlet of the first filter unit and the first inlet of the clean room equipment and a seventh damper in a sixth connecting pipe connecting the second filter unit outlet of the first filter unit and the second inlet of the clean room equipment are blocked, and
a sixth damper in a seventh connecting pipe connecting the third filter unit outlet of the second filter unit and the first inlet of the clean room equipment and an eighth damper in an eighth connecting pipe connecting the fourth filter unit outlet of the second filter unit and the second inlet of the clean room equipment are opened.

7. The air conditioning system of claim 1, wherein:
the first filter unit includes a first filter unit outlet and a second filter unit outlet;
the second filter unit includes a third filter unit outlet and a fourth filter unit outlet;
the first inlet of the clean room equipment is configured to receive filtered air from the first filter unit outlet of the first filter unit or filtered air from the third filter unit outlet of the second filter unit;
the second inlet of the clean room equipment is configured to receive filtered air from the second filter unit outlet of the first filter unit or filtered air from the fourth filter unit outlet of the second filter unit; and
the air conditioning system is configured to selectively direct air flow from the temperature control unit, through the first filter unit, and to the clean room equipment, during the operation of the first filter module, such that
a fifth damper in a fifth connecting pipe connecting the first filter unit outlet of the first filter unit and the first inlet of the clean room equipment and a seventh damper in a sixth connecting pipe connecting the second filter unit outlet of the first filter unit and the second inlet of the clean room equipment are opened, and
a sixth damper in a seventh connecting pipe connecting the third filter unit outlet of the second filter unit and the first inlet of the clean room equipment and an eighth damper in an eighth connecting pipe connecting the fourth filter unit outlet of the second filter unit and the second inlet of the clean room equipment are blocked.

8. The air conditioning system of claim 6, wherein
the fifth damper, the sixth damper, the seventh damper, and the eighth damper are each configured to be manually operated or electrically operated.

9. The air conditioning system of claim 1, wherein
the first filter unit includes a door connected to one surface of the first filter unit;
the second filter unit includes a separate door connected to one surface of the second filter unit; and
the door of the first filter unit and the separate door of the second filter unit are at opposite sides in relation to each other and face in opposite directions along an axis that intersects both the first filter unit and the second filter unit.

10. The air conditioning system of claim 1, wherein
the first filter unit includes a door connected to one surface of the first filter unit;
the second filter unit includes a separate door connected to one surface of the second filter unit; and
the door of the first filter unit and the separate door of the second filter unit face a same direction and are side by side.

11. The air conditioning system of claim 1, wherein
the first filter unit includes a door connected to one surface of the first filter unit;
the second filter unit includes a separate door connected to one surface of the second filter unit; and
the door of the first filter unit and the separate door of the second filter unit are positioned side by side while facing opposite directions along respective axes that are each orthogonal to a separate axis that intersects both the first filter unit and the second filter unit.

12. An air conditioning method, comprising:
controlling a temperature of purified air to be in a set temperature range;
filtering the purified air controlled to be in the set temperature range through a first filter unit or a second filter unit; and
directing air filtered through the first filter unit or the second filter unit to flow into clean room equipment,
wherein the method further includes
during an operation of a first filter module of the first filter unit,
blocking the purified air controlled to be in the set temperature range from flowing into the second filter unit, and
flowing the purified air controlled to be in the set temperature range into the first filter unit, and
during an operation of a second filter module of the second filter unit, blocking the purified air controlled to be in the set temperature range from flowing into the first filter unit, and
flowing the purified air controlled to be in the set temperature range into the second filter unit.

13. The air conditioning method of claim 12, wherein
the flowing or the blocking of the purified air controlled to be in the set temperature range into the first filter unit and the second filter unit is performed based on using a manual damper or a motorized damper.

14. The air conditioning method of claim 12, further comprising:
blocking air from flowing from the first filter unit into the clean room equipment during the operation of the second filter module of the second filter unit.

15. The air conditioning method of claim 12, further comprising:
blocking air from flowing from the second filter unit into the clean room equipment during the operation of the first filter module of the first filter unit.

16. The air conditioning method of claim 14, wherein
the blocking of the air from flowing from the first filter unit into the clean room equipment is performed based on using a manual damper or a motorized damper.

17. The air conditioning method of claim 12, wherein
the first filter module and the second filter module each include at least one of a chemisorptive filter or a physisorptive filter.

18. An air conditioning system, comprising:
a temperature control unit including a first outlet and a second outlet, the temperature control unit configured to control a temperature of purified air and discharge the purified air through at least one of the first outlet or the second outlet;
a first filter unit that is configured to filter purified air received at the first filter unit from the temperature control unit based on using a first filter module;
a second filter unit that is configured to filter purified air received at the second filter unit from the temperature control unit based on using a second filter module; and
clean room equipment including a first inlet and a second inlet that are each configured to receive filtered air from at least one of the first filter unit or the second filter unit,
wherein the first filter unit and the second filter unit include separate, independent housings,
wherein the air conditioning system is configured to
during an operation of the first filter module to filter purified air received at the first filter unit from the temperature control unit, block air flow from the temperature control unit into the second filter unit and further block air flow from the second filter unit into both the first inlet of the clean room equipment and the second inlet of the clean room equipment, and
during an operation of the second filter module to filter purified air received at the second filter unit from the temperature control unit, block air flow from the temperature control unit into the first filter unit and further block air flow from the first filter unit into both the first inlet of the clean room equipment and the second inlet of the clean room equipment.

19. The air conditioning system of claim 18, wherein:
the first filter unit includes a first filter unit inlet, a second filter unit inlet, a first filter unit outlet, and a second filter unit outlet;
the second filter unit includes a third filter unit inlet, a fourth filter unit inlet, a third filter unit outlet, and a fourth filter unit outlet;
the air conditioning system is configured to cause air discharged through the first outlet of the temperature control unit to flow into either the first filter unit inlet of the first filter unit or into the third filter unit inlet of the second filter unit;
the air conditioning system is configured to cause air discharged through the second outlet of the temperature control unit to flow into either the second filter unit inlet of the first filter unit or into the fourth filter unit inlet of the second filter unit;
the air conditioning system is configured to cause the first inlet of the clean room equipment to receive filtered air from either the first filter unit outlet of the first filter unit or the third filter unit outlet of the second filter unit;
the air conditioning system is configured to cause the second inlet of the clean room equipment to receive filtered air from either the second filter unit outlet of the first filter unit or the fourth filter unit outlet of the second filter unit; and
the air conditioning system is configured to selectively direct air flow from the temperature control unit, through the second filter unit, and to the clean room equipment during the operation of the second filter module, such that
a first damper in a first connecting pipe connecting the first outlet of the temperature control unit and the first filter unit inlet, a third damper in a second connecting pipe connecting the second outlet of the temperature control unit and the third filter unit inlet, a fifth damper in a fifth connecting pipe connecting the first filter unit outlet and the first inlet of the clean room equipment, and a seventh damper in a seventh connecting pipe connecting the third filter unit outlet and the first inlet of the clean room equipment are blocked, and
a second damper in a third connecting pipe connecting the first outlet of the temperature control unit and the second filter unit inlet, a fourth damper in a fourth connecting pipe connecting the second outlet of the temperature control unit and the fourth filter unit inlet, a sixth damper in a sixth connecting pipe connecting the second filter unit outlet and the second inlet of the clean room equipment, and an eighth damper in an eighth connecting pipe connecting the fourth filter unit outlet and the second inlet of the clean room equipment are opened.

20. The air conditioning system of claim 18, wherein:
the first filter unit includes a first filter unit inlet, a second filter unit inlet, a first filter unit outlet, and a second filter unit outlet;
the second filter unit includes a third filter unit inlet, a fourth filter unit inlet, a third filter unit outlet, and a fourth filter unit outlet;
the air conditioning system is configured to cause air discharged through the first outlet of the temperature control unit to flow into the first filter unit inlet of the first filter unit or into the third filter unit inlet of the second filter unit;
the air conditioning system is configured to cause air discharged through the second outlet of the temperature control unit to flow into either the second filter unit inlet of the first filter unit or into the fourth filter unit inlet of the second filter unit;
the air conditioning system is configured to cause the first inlet of the clean room equipment to receive filtered air from either the first filter unit outlet of the first filter unit or the third filter unit outlet of the second filter unit;
the air conditioning system is configured to cause the second inlet of the clean room equipment to receive filtered air from either the second filter unit outlet of the first filter unit or the fourth filter unit outlet of the second filter unit; and
the air conditioning system is configured to selectively direct air flow from the temperature control unit, through the first filter unit, and to the clean room equipment during the operation of the first filter module, such that
a first damper in a first connecting pipe connecting the first outlet of the temperature control unit and the first filter unit inlet, a third damper in a second connecting pipe connecting the second outlet of the temperature control unit and the third filter unit inlet, a fifth damper in a fifth connecting pipe connecting the first filter unit outlet and the first inlet of the clean room equipment, and a seventh damper in a seventh connecting pipe connecting the third filter unit outlet and the first inlet of the clean room equipment are opened, and
a second damper positioned in a third connecting pipe connecting the first outlet of the temperature control unit and the second filter unit inlet, a fourth damper positioned in a fourth connecting pipe connecting the second outlet of the temperature control unit and the fourth filter unit inlet, a sixth damper positioned in a sixth connecting pipe connecting the second filter unit outlet and the second inlet of the clean room equipment, and an eighth damper positioned in an eighth connecting pipe connecting the fourth filter unit outlet and the second inlet of the clean room equipment are blocked.
